(19) United States
(12) Patent Application Publication
(10) Pub. No.: US 2010/0030962 A1
(43) Pub. Date: Feb. 4, 2010

(54) STORAGE FACILITY FOR DATA HANDLING DEVICES

(76) Inventor: Sherif Sirageldin, Pinellas, FL (US)

Correspondence Address: ITALIA IP, 3500 WEST OLIVE AVE., SUITE 300, BURBANK, CA, 91505, US

(21) Appl. No.: 12/185,764

(22) Filed: Aug. 4, 2008

(51) Int. Cl. G06F 12/00

(52) U.S. Cl. 711/115; 711/E12.001

(57) ABSTRACT

A storage device for use in combination with a data handling device such as a PC, hand held communications device, and the like, of the type having a data port for receiving ancillary apparatus such as memory cards. The device may be in the form of a tray, or may have recesses shaped to accommodate various objects to be stored at the data handling device. These objects may have data handling functions, such as memory cards, or may be small personal effects such as coins and toiletry items. The tray may have prongs which face the data port, for guiding the tray into place during insertion and securing the tray in place. The tray may also have a cover to retain the objects when either inserted in the data port or not.

### FIELD OF THE INVENTION

The invention relates to storage accessories for use with data handling devices such as a PC, hand held communications devices, and the like. More particularly, the device serves as a facility which is removably received within the data handling device.

### BACKGROUND OF THE INVENTION

Computers and other electronic data handling devices have become increasingly diverse in their capacity to support peripheral data devices and connectors. Data handling devices are increasingly designed to be portable and intended to be operable in locations lacking convenient supporting surfaces and storage, such as desktop computers for accommodating peripheral items and personal objects. A variety of insertable memory media such as memory cards or sticks, as well as cables, controllers, power and signal connectors and conductors, mouse connectors, and listening devices require suitable ports, hubs, or slots, and like receptacles for receiving these peripheral components and adjunct memory devices. Portable data handling devices, such as laptop and notebook computers, are typically delivered with data ports in which may take the form of slots for example, for accepting various multi-media cards. This holds true not only with portable computers but also with data handling devices such as digital cameras and MP3 players, to name but a few.

Data handling devices do not offer convenient storage means for accommodating peripheral memory cards and the like when the latter are not actively being used. Additionally, many of these devices are delivered with data ports such as a PCMCIA slot that is not used.

A need exists for convenient, secure temporary storage of small ancillary devices in an orderly, accessible fashion.

### SUMMARY OF THE INVENTION

In light of the above need for convenient, easily accessible, and organized ancillary storage associated with use of data handling devices, the invention provides a storage facility for small articles, which storage space is usable with data handling devices such as laptop and notebook computers, digital communications devices, and the like. The storage facility may be in the form of a tray which is slidably received in the data port of the data handling device to which the tray may be connected. The storage facility may have at least one recess or partition which may loosely surround articles to be stored, or is dimensioned and configured to receive and cooperate closely with articles which are to be held by the storage facility.

The storage facility may be upwardly open or upwardly facing so that articles may be inserted and retrieved from above. Illustratively, the storage facility may be relatively flat and bounded by upwardly projecting walls, as is typical of trays, and may be inserted into the data port of the data handling device. An article such as a memory card may be inserted into an upwardly opening recess formed in the storage facility. The stored article may be subsequently retrieved for use. Obviously, diverse articles may be similarly stored awaiting use.

It is therefore an object of the invention to provide for convenient, removable retention and storage of small articles at a portable data handling device such as a desktop or laptop computer, an electronic or digital communications device, or the like.

It is another object of the invention to provide a storage device which exploits existing slots formed in the portable data handling device to support a storage facility, so that the storage facility may be readily inserted into, retained by, and removed from the portable data handling device.

A further object of the invention is to positively retain stored articles within the storage facility.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an exploded perspective view of a data processing device and an associated storage facility according to at least one aspect of the invention.

FIG. 2 is a perspective view of FIG. 1, showing the storage facility installed within the data processing device.

FIG. 3 is a perspective view of a storage facility according to another aspect of the invention.

FIG. 4 is a side view of the storage facility of FIG. 3, showing memory cards stored therein.

FIG. 5 is a perspective view of a storage facility according to still another aspect of the invention.

FIG. 6 is a perspective view of a storage facility according to yet another aspect of the invention.

FIG. 7 is a perspective view of a storage facility according to yet a further aspect of the invention.

FIG. 8 is a top plan view of a storage facility according to another aspect of the invention.

FIG. 9 is a side view of a storage facility according to still another aspect of the invention.

FIG. 10 is a block diagram summarizing steps of a method according to still another aspect of the invention, and is read from left to right.

FIG. 11 is an exploded perspective view of storage facility according to still another aspect of the invention and associated cover.

FIG. 12 is a perspective view of FIG. 12, showing the storage facility with the cover installed.

### DETAILED DESCRIPTION

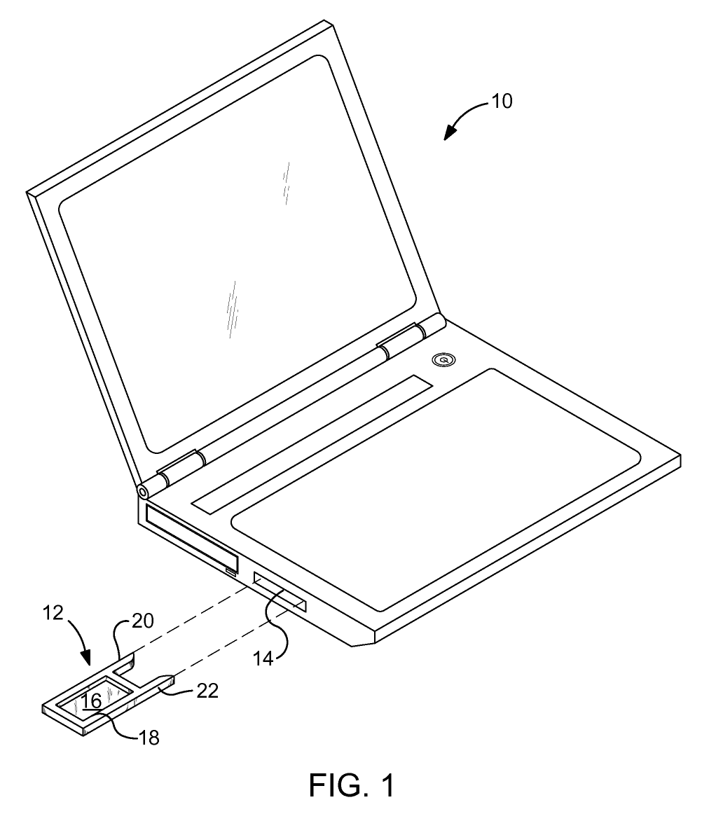

FIG. 1 of the drawings shows a data processing device 10 and an auxiliary storage facility 12 for storing at least one article (not shown) at the data processing device 10 according to one aspect of the invention. Articles which are contemplated as being subject to storage at the data processing device 10 may include both those which are related to the function of the data processing device 10, such as for example memory cards, and also those not related to the function of the data processing device 10. Examples of the latter include coins, keys, toiletries, hardware and fasteners, pills and tablets, credit cards and other magnetic and digital devices, writing and marking instruments, tools, office supplies such as staples and tacks among others, postage stamps, tokens, jewelry and medallions, business cards, amusement devices, optical pointers, styluses, and other small objects. The data processing device 10 may be a laptop or desktop computer, or other devices which operate using magnetic, digital, and electronic media.

The data processing device 10 will be understood to be representative of any portable device having at least one data handling port 14 for removably receiving a peripheral data handling device (not shown), or a port for removably receiving devices intended to transmit electrical operating energy or communications signals, whether these be electrical, optical, or based on other forms of energy, or both power and communications signals. Because it is depicted in representative capacity, the data processing device 10 will be understood to include components such as screen, keyboard, central processor, and the like, even though these components are not explicitly shown. Peripheral data handling devices encompass functions which support, expand, increase, enchance, and otherwise improve on the original capabilities of the data handling device 10, and may include items such as PCMCIA cards, ExpressCards (RTM), and the like. The data handling port 14 may receive signals, transmit signals, or both.

The storage facility 12 comprises a storage surface 16 bounded by a periphery, a confinement element such as an upwardly projecting perimetric wall 18, and a connector element which is dimensioned and configured to be removably received and supported by the data port 14 by inserting part of the storage facility, such as the prongs 20, 22 into the data port 14. The perimetric wall 18 is so-called as it joins the storage surface 16 at the periphery of the latter. The perimetric wall 18 is a low wall which may project upwardly above the level of the storage surface 16 by a magnitude of for example the height of the data port 14.

As employed herein, orientational terms such as vertical, height, and upwardly facing will be understood to refer to the orientations depicted in the referenced drawing figures. In turn, the drawing figures depict their subject matter in orientations of normal use, such as supported on a horizontal tabletop or desktop.

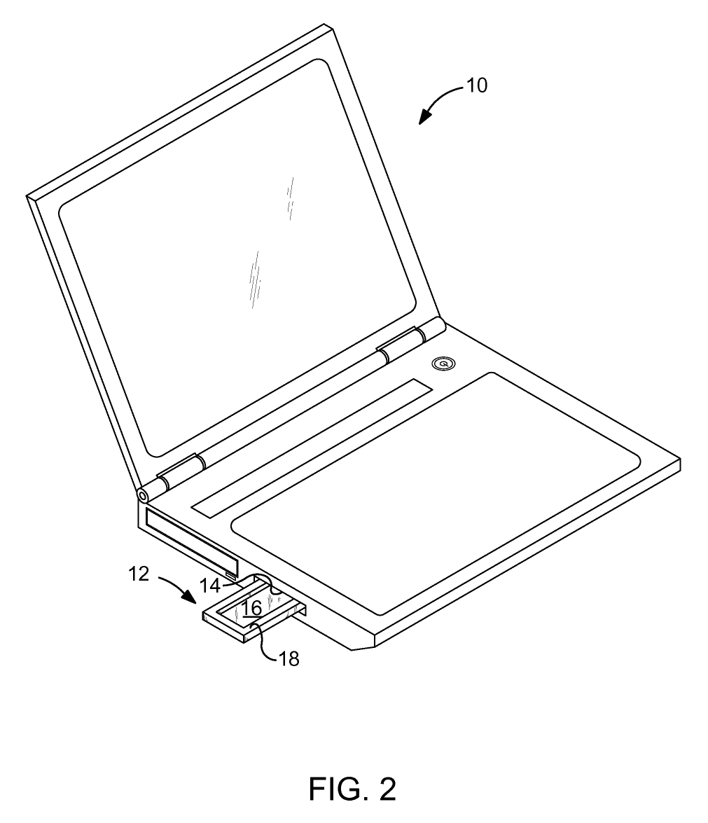

FIG. 2 shows the storage facility 12 partially inserted into the data port 14 such that part of the storage facility 12 occupies the data port 14 and part of the storage facility 12 remains upwardly open and accessible at the exterior of the data handling device 10. Access to the exteriorly exposed storage surface 16 from above is unobstructed by the confinement element (i.e. the perimetric wall 18) when the storage facility 12 is inserted into and supported by the data port 14. Once loaded with articles to be stored, the storage facility 12 may be fully inserted into the data port 14.

It should be noted at this point that reference to component parts of the storage facility, such as the storage surface 16 of the storage facility 12, the confinement element, and the connector element need not imply that these component parts be separate, distinct structural elements. As will be further described hereinafter, the connector element may for example comprise an extension of the storage elements of the storage facility, with no discernible point of demarcation. Similarly, the confinement element may be integral with the storage surface.

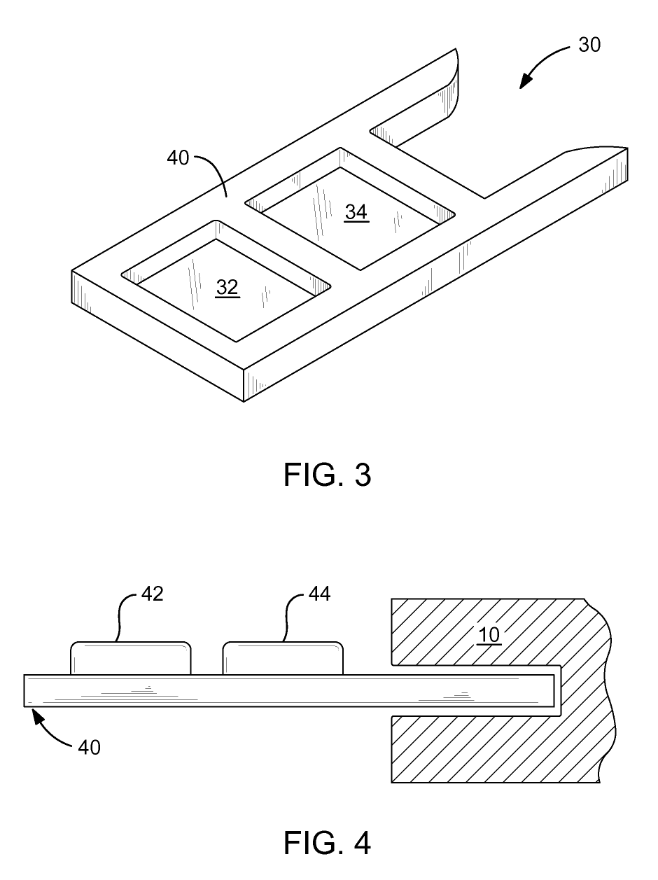

As illustrated in FIG. 3, a storage facility 30 according to another aspect of the invention, which storage facility 30 may be slidably received by the data port 14, may comprise more than one recess formed in its storage surface. More particularly, the storage facility 30 may have recesses 32, 34 which project downwardly into the storage surface 40.

According to a further aspect of the invention a storage facility such as the storage facility 30 may project from the host appliance into which it is inserted. This contrasts with the storage facility 12 of FIG. 1, which may be fully insertable into its associated data port 14. Referring again to the storage facility 30 of FIG. 3, each one of the recesses 32, 34 may be configured to cooperate closely with articles to be stored therein, such as battery cells 42, 44. Close cooperation implies that when an article is inserted into the subject recess, such as the recess 32, that article is held in place substantially in the orientation in which it assumed when inserted, and is constrained against casual loss or dislodging by frictional grip. The frictional grip is not so great as to oppose ready removal by hand. In FIG. 4, the storage facility 40 has greater length than does the storage facility 30 of FIG. 3, so that part of storage facility 30A remains outside the host appliance, such as the data handling device 10.

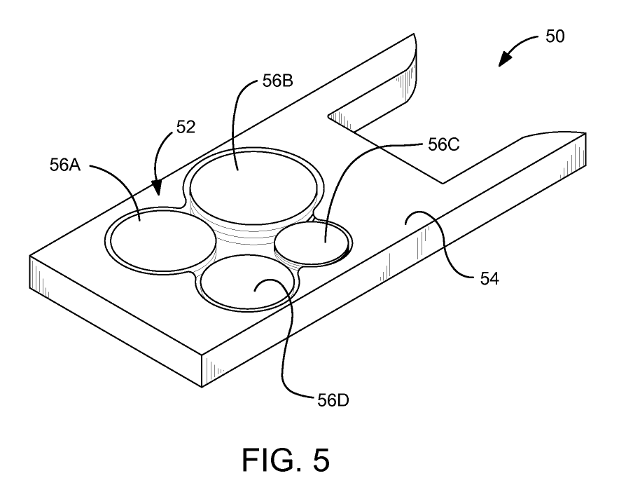

FIG. 5 shows a storage facility 50 according to still another aspect of the invention, which may be received by the data port 14. The storage facility 50 may have a recess 52 formed in a storage surface 54. In the example of FIG. 5, the recess 52 is configured as a clover leaf. The recess 52 may accommodate a plurality of discs such as coins 56A, 56B, 56C, 56D.

FIG. 6 shows a storage facility 60 according to still another aspect of the invention, which may be received by the data port 14. The storage facility 60 may have formed in a storage surface 62 a first recess 64 which is configured to receive and cooperate closely with two discs which may be similar to the coin 56A, 56B for example, a second recess 66, and a third recess 68. The recesses 66, 68 may be dimensioned and configured differently from the recess 64. In summary, the storage facility 60 may have recesses, such as the recesses 64, 66, 68, which are of different characteristics such that at least two varieties of articles may be stored by the storage facility 60.

The storage facility 60 may have a connector element in the form of arms or prongs 70, 72. The function of the prongs 70, 72 is to extend the outer lateral surface area of the storage facility 60, such as the surface 74, which contacts surfaces of the associated data port, such as the data port 14, so as to provide adequate support to the storage facility 60 in the installed position. To this end, the prongs 70, 72 may extend in the direction of insertion when the storage facility 60 is being inserted into the data port of the data processing device 10, so as to present lateral surface area to the data port surfaces for effective contact and support.

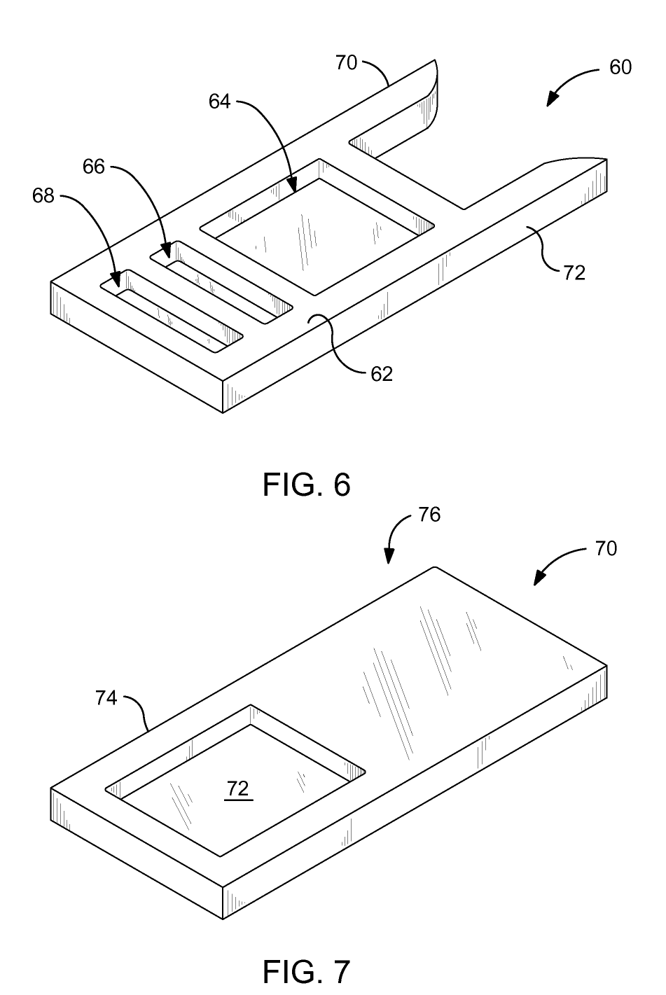

The connector element may comprise prongs such as the prongs 70, 72, which may be spaced apart as shown in FIG. 6. As an alternative, and referring now to FIG. 7, a storage facility 70 according to still a further aspect of the invention, which may be received by the data port 14, may have a storage surface 72, a confinement element in the form of a perimetric wall 74, and a connector element 76. The connector element 76 may be formed as a parallelepiped rather than comprising prongs such as the prongs 70, 72 of FIG. 6. The connector element 76 may occupy the space within a data port, such as the data port 14, sufficiently to be securely held therein. However, in some cases, the space located between prongs such as the prongs 70, 72 may accommodate pins and other projecting energy transmissive terminals (none shown), so that prongs may in some cases be preferred to the configuration presented by the connector element 76.

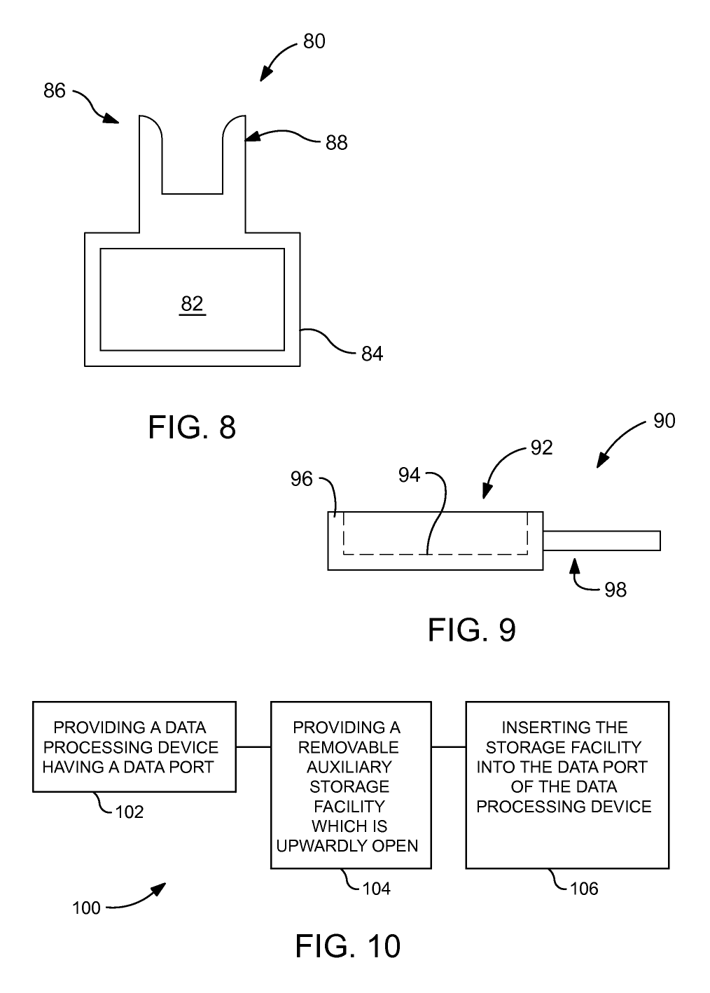

A storage facility may have dimensions exceeding those of the storage facilities already described. As seen in FIG. 8, a storage facility 80 according to still another aspect of the invention, which may be received by the data port 14, is seen to have a storage surface 82, a perimetric wall 84, and a connector element comprising two prongs 86, 88. The storage surface 82 and the perimetric wall 84 are seen to have width, referring to the dimension which extends from left to right in FIG. 8, which exceeds the corresponding width of the connector element. The storage facility 80 is among that storage facility which is not fully received into its associated port, as is the port 14 of FIG. 1.

FIG. 9 shows a storage facility 90 according to still another aspect of the invention, which may be received by the data port 14. The storage facility 90 may have a storage component 92 comprising a storage surface 94 and a perimetric wall 96, and a connector element 98, which connector element 98 may be similar to the connector element of any of the storage facilities 12, 30, 50, 60, 70, and 80 for example. It will be seen in the side view of FIG. 9 that the height of the storage component 92 exceeds the height of the connector element 98.

Referring now to FIG. 10, the invention according to still another aspect may comprise a method 100 for providing a storage facility for small articles in conjunction with a data processing device having a data port for supporting and communicating with peripheral data handling devices.

The method 100 may comprise a step 102 of providing a data processing device such as the data processing device 10, having a data port such as the data port 14, for removably receiving a peripheral data handling device such as the memory card 42.

The method 100 may further comprise a step 104 of providing a removable auxiliary storage facility such as the storage facility 12, which is dimensioned and configured to be removably received and supported by the data port by inserting part of the storage facility into the data port, wherein the storage facility has a storage surface such as the storage surface 16 and a confinement element, such as the perimetric wall 18, for retaining at least one stored article on the storage surface, wherein at least part of the storage surface remains upwardly open and accessible at the exterior of the data handling device, and access to the exteriorly exposed storage surface is unobstructed by the confinement element, when the storage facility is inserted into and supported by the data port.

The method 100 may further comprise a step 106 of removably inserting the auxiliary storage facility into the the data processing device at the data port when the data port is vacant, such that the storage surface is accessible from the exterior of the data processing device for insertion of a small article thereinto when the auxiliary storage facility is inserted into the data processing device.

The method 100 may be extended to include steps (not shown) such as storing one or more articles within the storage facility, and to include steps of varying the storage facility as described in greater detail elsewhere herein.

The storage facilities as described herein, such as the storage facilities 12, 30, 50, 60, 70, 80, and 90 may be modified from the forms as presented. Notably, any storage facility may have any article containing recess, such as the recesses 64, 66, 68. The number, dimensions, and configurations of the various recesses of any storage facility according to at least one aspect of the invention may be varied and combined as desired.

It will be appreciated that the confinement element, such as the perimetric wall 18 of FIG. 1, need not extend continuously along its associated storage surface, such as the storage surface 16. It may for example be interrupted by gaps (not shown). Therefore, it may be said that the confinement element such as the perimetric wall 18 projects upwardly from at least part of the perimeter of the associated storage surface, such as the storage surface 16.

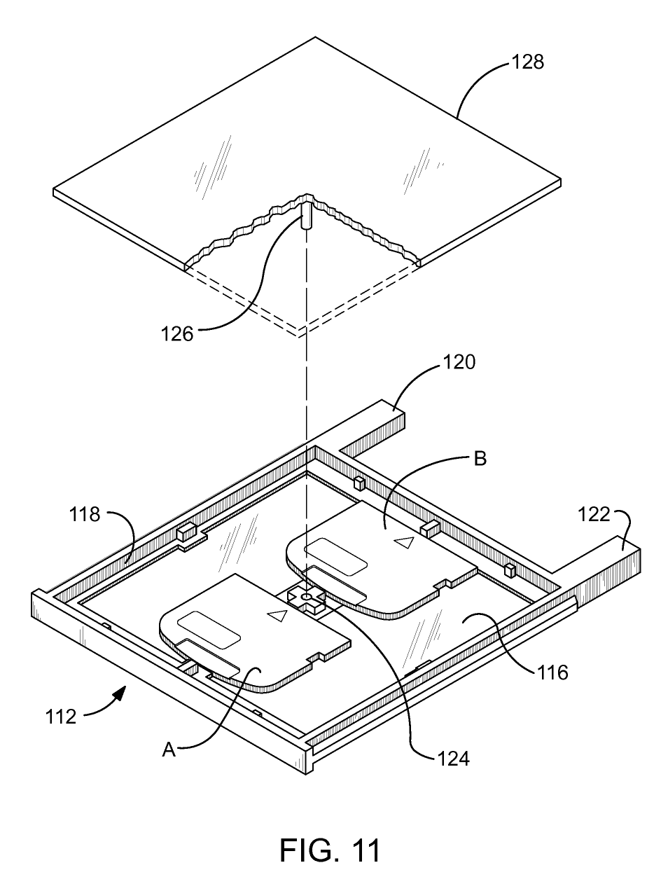

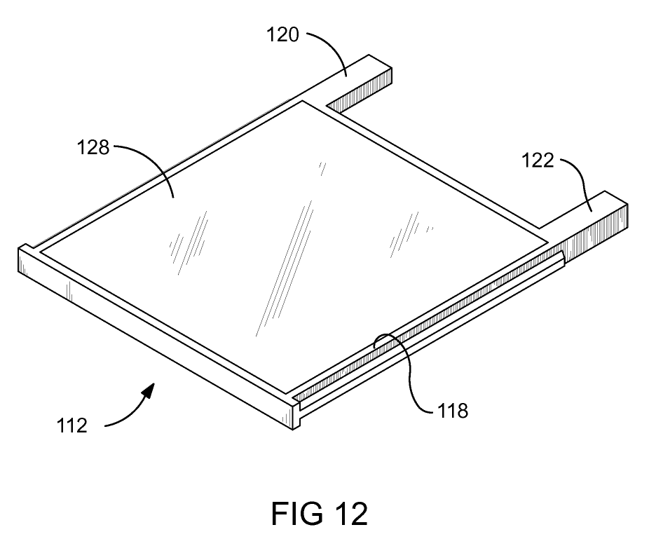

A further embodiment of the invention is shown in FIGS. 11 and 12. In this embodiment, the storage facility 112 comprises a storage surface 116 bounded by a periphery, a confinement element such as an upwardly projecting perimetric wall 118, and a connector element which is dimensioned and configured to be removably received and supported by the data port 14 of a by inserting part of the storage facility, such as the prongs 120, 122 into the data port 14. In this embodiment the storage surface 116 includes a post receiving element 124, which is able to removably receive a post element 126 integral with a cover member 128. The cover member 128 and perimetric wall 118 are dimensionally configured to allow for mating engagement, and the cover member is removably retained to the storage facility 112 through the frictional engagement of the post receiving element 124 and the post member 126. When such components are engaged, elements contained in the storage surface 116, such as the memory cards A and B, are held in place and prevented from escaping from the facility 112 whether it is retained in the data port 14 or not.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A data processing device and auxiliary storage facility for storing at least one article at the data processing device, comprising:
a data processing device having at least one signal handling port for removably receiving a peripheral data handling device; and
a storage facility which is dimensioned and configured to be removably received and supported by the data port by inserting part of the storage facility into the data port, wherein the storage facility comprises a storage surface and confinement element for retaining at least one stored article on the storage surface, and wherein at least part of the storage surface remains upwardly open and accessible at the exterior of the data handling device, and access to the exteriorly exposed storage surface is unobstructed by the confinement element, when the storage facility is inserted into and supported by the data port.

2. The data processing device and auxiliary storage facility for storing at least one article at the data processing device according to claim 1, wherein the storage facility comprises a tray wherein the storage surface further comprises an upwardly open and accessible floor surface having a perimeter, and the confinement element comprises a short wall projecting upwardly from at least part of the perimeter.

3. The data processing device and auxiliary storage facility for storing at least one article at the data processing device according to claim 1, wherein the confinement element comprises at least one recess formed in the storage surface, and wherein the recess conforms closely to one article which has been inserted into the recess.

4. The data processing device and auxiliary storage facility for storing at least one article at the data processing device according to claim 1, wherein the confinement element comprises at least one recess formed in the storage surface, and wherein the recess conforms closely to a plurality of articles which have been inserted collectively into the recess.

5. The data processing device and auxiliary storage facility for storing at least one article at the data processing device according to claim 4, wherein the confinement element comprises more than one recess formed in the storage surface.

6. The data processing device and auxiliary storage facility for storing at least one article at the data processing device according to claim 4, wherein the recesses are of different characteristics such that at least two varieties of articles may be stored by the auxiliary storage facility.

7. The data processing device and auxiliary storage facility for storing at least one article at the data processing device according to claim 1, wherein the storage facility has at least one prong extending in the direction of insertion when the storage facility is being inserted into the data port of the data processing device, and wherein the prong is functional to extend the surface area of the storage facility which contacts surfaces of the data port.

8. The data processing device and auxiliary storage facility for storing at least one article at the data processing device according to claim 1 further comprising a cover member for removable attachment to at least a portion of said storage facility.

9. An auxiliary storage facility for storing at least one article, for use with a data processing device having a data port, the storage facility comprising:
a storage surface;
a confinement element for retaining at least one stored article on the storage surface; and
a connector which is dimensioned and configured to be slidably received within and supported by the data port of a data processing device.

10. The auxiliary storage facility for storing at least one article according to claim 9, wherein the storage surface comprises an upwardly open and accessible floor surface having a perimeter, and the confinement element comprises a short wall projecting upwardly from at least part of the perimeter.

11. The auxiliary storage facility for storing at least one article according to claim 9, wherein the confinement element comprises at least one recess formed in the storage surface, and wherein the recess conforms closely to one article which has been inserted into the recess.

12. The auxiliary storage facility for storing at least one article according to claim 9, wherein the confinement element comprises at least one recess formed in the storage surface, and wherein the recess conforms closely to a plurality of articles which have been inserted collectively into the recess.

13. The auxiliary storage facility for storing at least one article according to claim 9, wherein the confinement element comprises more than one recess formed in the storage surface.

14. The auxiliary storage facility for storing at least one article according to claim 13, wherein the recesses are of different characteristics such that at least two varieties of articles may be stored by the auxiliary storage facility.

15. The auxiliary storage facility for storing at least one article according to claim 9, further comprising at least one prong extending in the direction of insertion when the storage facility is being inserted into the data port of a data processing device, and wherein the prong is functional to extend the surface area of the storage facility which contacts surfaces of the data port.

16. The auxiliary storage facility for storing at least one article according to claim 9, further comprising two spaced apart prongs each extending in the direction of insertion when the storage facility is being inserted into the data port of a data processing device, and wherein the prongs are functional to extend the surface area of the storage facility which contacts surfaces of the data port.

17. The data processing device and auxiliary storage facility for storing at least one article at the data processing device according to claim 9 further comprising a cover member for removable attachment to at least a portion of said storage facility.

18. A method for providing a storage facility for small articles in conjunction with a data processing device having a data port for supporting and communicating with peripheral data handling devices, comprising the steps of:
providing a data processing device having a data port for removably receiving a peripheral data handling device;
providing a removable auxiliary storage facility which is dimensioned and configured to be removably received and supported by the data port by inserting part of the storage facility into the data port, wherein the storage facility has a storage surface and confinement element for retaining at least one stored article on the storage surface, wherein at least part of the storage surface remains upwardly open and accessible at the exterior of the data handling device, and access to the exteriorly exposed storage surface is unobstructed by the confinement element, when the storage facility is inserted into and supported by the data port; and
removably inserting the auxiliary storage facility into the data processing device at the data port when the data port is vacant, such that the storage surface is accessible from the exterior of the data processing device for insertion of a small article thereinto when the auxiliary storage facility is inserted into the data processing device.

19. The method for providing a storage facility for small articles in conjunction with a data processing device having a data port for supporting and communicating with peripheral data handling devices of claim 18, further comprising the step of providing a cover member for removable attachment to at least a portion of said storage facility.
